(19) United States
(12) Patent Application Publication
(10) Pub. No.: US 2005/0187322 A1
(43) Pub. Date: Aug. 25, 2005

(54) Polyamide resin composition for microcellular foaming injection molding

(76) Inventors: Eun Ha Park, Gumi-si (KR); Byung Hun Park, Seoul (KR); Young Kyun Jung, Gumi-si (KR); Young Moo Park, Ansan-si (KR); Soo Chul Park, Gwangmyeong-si (KR)

Correspondence Address: MORGAN, LEWIS & BOCKIUS LLP (SF), 2 PALO ALTO SQUARE, PALO ALTO, CA, 94306, US

(21) Appl. No.: 11/031,786

(22) Filed: Jan. 6, 2005

(30) Foreign Application Priority Data
Jan. 6, 2004 (KR) 10-2004-0000638
May 24, 2004 (KR) 10-2004-0036935

(51) Int. Cl. C08K 3/34; C08K 3/40; C08K 5/09

(52) U.S. Cl. 524/284; 524/494; 524/445

(57) ABSTRACT

A polyamide resin composition for microcellular foaming injection molding relates to a polyamide resin composition including a polyamide resin, a glass fiber, a mineral, and sulfonamide-based or dicarboxylic acid-based plasticizer. The resin enables a decrease in the weight of the manufactured goods and improved surface properties without showing any defect, such as surface sink and flowmark, or any reinforcing materials, such as glass fiber and clay, on the surface, while elevating other physical properties such as heat resistance, fluidity, and rigidity.

### CROSS REFERENCE TO RELATED APPLICATION(S)

This application claims priority to Korean Patent Application no.2004-0000638, filed Jan. 6, 2004, and Korean Patent Application no.2004-0036935, filed May 24, 2004, the disclosures of which are incorporated herein by reference in their entirety.

### TECHNICAL FIELD OF THE INVENTION

Generally, the present invention relates to a polyamide resin composition for microcellular foaming injection molding. In particular, the polyamide resin composition comprises a polyamide resin, a glass fiber, mineral, and sulfonamide-based or dicarboxylic acid-based plasticizer, which enables a decrease in the weight of the manufactured goods and improved surface properties without showing any defects, such as surface sink and flowmark, or leaving any reinforcing materials, such as glass fiber and clay, on the surface while elevating other physical properties such as heat resistance, fluidity, and rigidity.

### BACKGROUND OF THE INVENTION

Recently, along with rapid development in the automotive industry and IT technology, researches have been focused on replacing conventional electric/electronic materials with plastics. This research has been focused with a view to obtaining light-weighted materials, enabling low production cost, increasing a degree of freedom in design, and simplifying the manufacturing process. Polyamide resins, as an example of such a potent material, have been widely used in industry due to its superiority in rigidity, dutility, abrasion resistance, chemical resistance, and particular effects exhibited when added with a reinforcing compound. However, polyamide resins are disadvantageous in that they have poor dimensional stability when they absorb moisture. Furthermore, as a crystalline polymer they have poor impact strength and relatively high molding shrinkage. Therefore, to remedy the aforementioned drawbacks of polyamide resins it has been suggested to use a polymer alloy or to add an inorganic substance. Thus, products are produced with the improved properties are generally used as parts of an automobile, such as an engine cover, a fan and a shroud, a radiator head tank, an air intake manifold, a timing-belt cover, and other housings or covers for various kinds of tanks or ducts.

There are several other methods that have been known to improve the aforementioned drawbacks of polyamide resins. For example, it has been known that an addition of a fibrous inorganic filler, such as glass fiber or glass beads, and an inorganic material, such as minerals of inorganic particles of talc, mica, clay, CaCO₃, Wollastonite, and barium sulfate, can improve the rigidity, heat resistance, and dimensional stability of polyamide resins. Similarly, in a so-called ‘hybrid’ reinforcing method, an inorganic filler or particle can be used alone or in combination with more than two of their kinds and excessively added in solid after being hybridized and undergoing an injection molding. In this method, inorganic fillers and particles are simultaneously mixed in order to reduce shrinkage anisotropy between axial (flow directional) and radial shrinkages among products generated from injection molding.

Further, there have been also disclosed methods to add a third additive or introduce a coupling agent, such as silane, to an inorganic material in order to further increase rigidity of a resulting product.

The above methods are disclosed in U.S. Pat. Nos. 4,131,591 and 3,843,591 and Japanese Pat. Nos. Sho 6-047063 and Sho 5-817440. Further methods are described in Japanese Pat. No. Sho 8-7235652 which discloses a method to form an alloy with polyphenylene resin or a rubber component which contains unsaturated carbonic acid. Korean Pat. No. 1994-0014663 discloses a technology to blend with polyolefin and an acid functional group. Moreover, Japanese Pat. Nos. Sho 5-628241, Hei 2-24354, and Hei 6-234896 disclose a technology where polyamide and polypropylene resins are blended and a glass fiber is added thereto using carboxylic acid as a compatibilizer. Japanese Pat. No. Hei 4-151962 and U.S. Pat. No. 4,613,647 teach to use aromatic polyamide for polyamide resin to be reinforced with glass fiber to improve rigidity.

Furthermore, as references which disclose a resin composition where glass fiber alone is used or combined along with a mineral to be reinforced, Japanese Pat. Nos. Sho 6-0108463 discloses improvement in the impact strength by introducing a coupling agent. Japanese Pat. No. Sho 6-047061 introduces a technology where a glass fiber is combined along with clay. Japanese Pat. No. Sho 59-133249 introduces a method to add glass fiber and a plasticizer, and Japanese Pat. No. Sho 58-201844 introduces a much improved technology where a trace amount of nylon 4,6 is used.

The above-mentioned methods disclose that addition of an inorganic filler and a particle to polyamide resin, whether used alone or in combination with other compounds to be reinforced, can strengthen the rigidity, heat resistance, dimensional stability, and impact-resistance of the resulting products. These methods also disclose that forming an alloy with other polyamide resins or adding a third additive to polyamide resin can improve the interfacial binding force between resins and between resin and an inorganic material to be introduced. The resulting products of which can be used as parts in automobiles or other essential parts to be used in industry. More specifically, the composition prepared by a filler reinforcing method can be applied to manufacture radiator head tanks or air intake manifold of an automobile. The composition containing an inorganic particle can be used for lid filler at a fuel injection inlet, outside door handle, or engine beauty covers. The complex reinforcing composition can be used for a fan and a shroud, a timing belt cover, and various kinds of ducts for the automobile.

In applying polyamide resin composition to manufacture various products as mentioned above, injection molding has been widely selected as a method to improve mechanical properties. However, if an excessive amount of an inorganic material is added during injection molding, the inorganic material becomes exposed on the surface of the resulting product, thus deteriorating the quality of the product. When the products produced by the injection molding are large they often experience bending and deforming due to the difference in shrinkage in both horizontal and vertical directions. In case of manufacturing thin film products, there occurs a problem in adjusting a filling balance, thus resulting in weld line, sink, flowmark after forming and hence, lowering product quality. The above-stated limitations become even more serious when an inorganic material is added alone to the polyamide resin composition, thus, making it difficult to acquire impact-resistance and heat resistance.

Further, in case of using polypropylene where an alloy is formed by combination with a third compound, heat resistance becomes poor and a further compatibilizer is required to improve compatibility between polyamide and polypropylene. Alloys, with other polyamides, such as aromatic polyamide or polyamide 4,6 resin, exhibit superior heat resistance, rigidity, and impact-resistance. However, they have a relatively high melting point and, thus, it becomes difficult to form large thin film products. In particular, when a coupling agent is not treated with the inorganic material, if an excessive amount of inorganic material is used, it results in a poor surface, thus, deteriorating the product quality. Furthermore, it becomes difficult to acquire good impact-resistance. Most polyamide resin compositions are provided with suitable scope of applications and generally there will be no problem as long as they are used within the preferred range of applications. However, if they are used as parts to perform highly sophisticated functions it may raise a few additional problems.

As stated above, the conventional technologies have been largely restricted in their applications for they are unable to meet all the required functions and physical properties. Most of the prior methods were only applicable to manufacture products prepared by means of injection molding.

A great deal of attempts have been made to improve the properties of polyamide resin compositions, for example, forming an alloy with a third polymer, developing a technology to reinforce an inorganic material, introducing conductibility and flame retardation, etc. Polyamides are generally superior to other resins in reinforcing effect when combined with inorganic materials and there are various kinds of reinforcing technologies using an inorganic material. That is, most of the technology to apply polyamide resin compositions to automotive parts mainly lie in how to apply the technology of reinforcing an inorganic material to the automotive industry. Although inorganic materials to be reinforced are rather small in size they cause an increase in specific gravity of the material, thus, raising an additional problem.

Other resins to be used to apply the alloy techniques are other polyamides, polypropylenes, polystyrenes, polyphenylene oxides, thermoplastic elastomers, and the like. These alloy compositions can be used alone depending on the uses and requirements of products and these alloys can be reinforced with an inorganic material.

In conductibility technology where carbon or other conductive inorganic materials are added, carbon fiber, carbon black powder, ferrite and graphite can be used. In flame retardation polyamide technology, halogenated flame retardant or melamine retardant or phosphorous retardant can be used.

The conventional resin compositions differ in their processes depending on their presumed uses and injection molding is widely used in automotives, electric/electro industry, general industry and other daily goods materials. The products produced via injection molding often have problems such as bending or deformation, surface sink, flowmark, weldline, etc. Therefore, various attempts have been made to avoid the above problems by modifying the properties of the resin compositions but there are still many limitations.

### SUMMARY OF THE INVENTION

As a result of enormous studies and research, to resolve the technical problems mentioned above, the present inventors provides a resin composition comprising a polyamide resin, glass fiber, mineral (inorganic materials), and additives in predetermined amounts. Therefore, the present invention aims to (i) improve ductility, chemical resistance, adding effect, surface properties by adopting polyamide as a base polymer, (ii) maximize heat resistance, rigidity, and dimensional stability by using composite reinforcement (in particular, by simultaneously adding minerals and glass fiber treated with a coupling agent), and (iii) lower the viscosity and retard the crystallization by adding certain additives, thus, further increase the surface properties.

Specifically, the resin composition of the present invention enables a decrease in the weight of the manufactured goods and improve surface properties, without showing any defect, such as surface sink and flowmark, or any reinforcing materials, such as glass fiber and clay, on the surface, while elevating other physical properties such as dimensional stability heat resistance, fluidity, and rigidity. Thereby, the resin composition is appropriate for use in automobile components such as a radiator fan, a shroud, an intercooler air duct, a timing belt cover, or a lid filler door.

The present invention is designed to provide a composition that can remedy aforementioned technical problems and limitations in uses that have been raised in the conventional technologies and produce products at a much lowered cost while enabling them to serve rather highly sophisticated functions. Further, the resin composition of the present invention has properties more suitable to microcellular foaming process, an injection molding process. The microcellular foaming process is designed to solve various technical problems which may occur in the course of injection molding and has drawn much public attention recently. The microcellular foaming process forms products by means of producing microcellular foams with a size of about 5-50 μm within polymers of plastic products. This process is a physical process employing supercritical fluid state and is also an environment-friendly process, thus, distinguishing itself from the general chemical foaming processes.

In the microcellular foaming process, an injection device, designed to introduce a nitrogen or carbon dioxide gas at supercritical fluid state, is attached to the center of a cylinder at the time of injection molding. A liquefied gas, under high pressure, is introduced into a mold to be mixed with a composition, thus, forming a single layered structure. The liquefied gas is then introduced into the mold along with the composition, then the gas forms a nucleus as there is a drastic decrease in pressure, thereby, forming microcellular foams within the composition and completing injection molding. The polyamide resin composition of the present invention is suitable for this kind of microcellular foaming process. The technology can be applied to fairly large thin film automotive parts such as a radiator fan or a shroud, an intercooler air duct, a timing belt cover, a lid filler door and the like.

To solve the above technical problems, efforts have been made to improve the resin compositions as well as the processing methods, and the microcellular foaming process has been welcomed as one of such methods. That is, when injection molding is used via microcellular foaming process, it results in forming microcellular foams within the final products and can avoid the bending or deformation of the final products. Furthermore, since the nitrogen gas or carbon dioxide is environment-friendly, the process is superior.

### DETAILED DESCRIPTION OF THE PREFERRED EMBODIMENTS

The present invention includes a polyamide resin composition for microcellular foaming injection molding. The composition includes not less than about 50 wt % and not more than about 75 wt % of a polyamide component which is a polyamide of formula 1 (polyamide 6) or a polymer alloyed with the polyamide and a polyamide of formula 2 (polyamide 66), 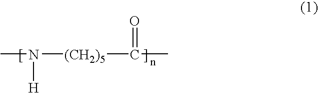
wherein n is an integer of not less than about 200 and not more than about 15,000, 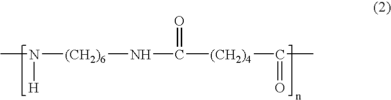
wherein n is an integer of not less than about 200 and not more than about 15,000. The composition also includes not less than about 15 wt % and not more than about 35 wt % of glass fiber, not less than about 5 wt % and not more than about 25 wt % of clay. Further included is not less than about 0.1 wt % and not more than about 3 wt % of a benzosulfonamide-based or a dicarboxylic acid-based plasticizer.

The polyamide resin composition of the present invention is preferred to have physical properties of (i) 62,000 kg/cm² or higher of flexural modulus according to ASTM D790, (ii) 5.5 kg.cm/cm or higher of impact strength according to ASTM D256, (iii) 120% or less of shrinkage in a flow direction and a radial direction, and (iv) 230° C. or higher of a heat deflection temperature according to ASTM D648, and thus may be applied to manufacture of automobile parts according to microcellular injection molding process.

As the polyamide component, a polyamide of formula 1 (polyamide 6) or a polymer alloyed with the polyamide and a polyamide of formula 2 (polyamide 66) may be used in the present invention. The weight ratio of the polyamide 6 to the polyamide 66 in the alloyed polymer is preferred to be lower than 1:1. If the amount of the polyamide 6 is higher than that of the polyamide 66, it is not preferred because the heat resistance or rigidity of the prepared polyamide resin composition may be deteriorated in spite of improvement of fluidity or surface properties.

The polyamide of formula 1 may be prepared according to a conventional process, as will be appreciated by one of ordinary skill in the art. For example, 100 weight parts of ε-caprolactam is added into a reactor heated to 260° C. along with 7.17 weight parts of water, 0.004 weight parts of a foam inhibitor, and 0.09 weight parts of a heat resistant agent, IrganoxB1171® (commercially available, 1:1 mixture of tris(2,4-di-tert-butylphenyl)phosphite and N,N′-hexamethylene-bis(3,5-di-tert-butyl-4-hydroxyhydrocyamide). A first reaction is performed for one hour after elevating the pressure to 15 kg/cm2, and then the pressure is lowered slowly after maintaining the pressure for 30 minutes. A second reaction is performed under the atmospheric pressure for 2 hours, and a third reaction is performed after lowering the pressure to −360 mmHg. Reaction is terminated by adding nitrogen, thus obtaining the polyamide of formula 1.

Further, a polyamide of formula 2 may also be prepared by conventional process, as will be appreciated by one of ordinary skill in the art. For example, hexamethylenediamine adipate salt (hereinafter, “AH” salt) and an appropriate amount of water are added into an autoclave for polymerization of polyamide resin, which is equipped with a stirrer, a thermostat, a temperature controller and a steam reflux cooler. After reactants are admixed by using the stirrer while elevating the temperature, slurry prepared by mixing various additives, methanol and water is added into the autoclave, thereby obtaining the polyamide of formula 2.

Moreover, acetic acid may be added as a viscosity stabilizer, and hexamethylene diamine and defoamer may also be added. Polyamide may be prepared by polymerization after removing oxygen inside the autoclave by purging nitrogen with high purity.

Reaction conditions adopted in preparation of polyamide of formula 1 is provided in the following TABLE 1:

TABLE 1

| | | | Time |
|---|---|---|---|
| Step | Pressure (kg/cm²) | Temperature (° C.) | (min) |
| Elevation of | Atmospheric press. → 17.5 | 120 → 230 | 60 |
| temp. | | | |
| & press. | | | |
| Controlling | Maintaining at 17.5 | 230 → 255 | 80 |
| of press. | | | |
| Lowering | 17.5 → | 255 → 270 | 70 |
| of press. | Atmospheric press. | | |
| Maintaining | Atmospheric press. | 270 → 275 | 30 |
| Dispensing | Atmospheric press. → 2.5 | 275 → 280 | 20 |

As the temperature is elevated, the pressure in turn rises inside the autoclave. Temperature is elevated for one hour from 120° C. to 230° C. When the pressure is raised to 17.5 kg/cm², the pressure is maintained by effluxing steams while the temperature is elevated to 250° C., followed by lowering the pressure to an atmospheric pressure for 70 minutes. After pressure is maintained for 30 minutes, reaction is terminated by adding nitrogen into the autoclave at a flow rate of 2-2.5 kg/cm², thereby obtaining desired polyamide via the step of dispensing. Prepared polyamides of formulas of 1 and 2 are manufactured in the form of chip and used after drying at 90° C. for 5 hours.

The polyamide component is preferred to have a relative viscosity of not less than about 2.3 and not more than about 3.0 (20° C., 1 g polymer/100 ml of 96% sulfuric acid). If the relative viscosity is below about 2.3 there is a problem of decreased rigidity and impact resistance. In contrast, there is difficulty in surface expression or molding process if the relative viscosity is beyond about 3.0.

Meanwhile, the polyamides of formulas 1 and 2 may be used in a conventional injection molding process (hereinafter, “solid process”). However, the polyamide of the present invention is may also be appropriate in the use of microcellular foaming process by using composite reinforcement, especially, glass fiber and mineral, and plasticizer compatible with polyamide, thereby enabling to overcome the problems of shrinkage anisotropy, in injection molding process, as well as surface deterioration, in microcellular foaming process.

Thus, the advantages of light weight and little deflection may be accomplished by the injection molding according to the microcellular foaming process. The drawbacks of surface defects and low mechanical strength of the conventional resin is overcome by using gas in the step of foaming and adding glass fiber or minerals.

Conventional glass fiber, which is in the form of chop and commonly referred to as ‘G’ or ‘K’ glass, may also be used as the glass fiber of the present invention. Main ingredients of the glass fiber are CaO (10-20 wt %), SiO₂ (50-70 wt %) and Al₂O₃ (2-15 wt %). The glass fiber is preferred to be surface-modified by coupling treatment with silane for higher interfacial adhesion between the glass fiber and the final composition. Preferably, the glass fiber has a diameter of not less than about 10 μm and not more than about 13 μm and a length of not less than about 3 mm and not more than about 3.5 mm, and is comprised in the total composition in the amount of not less than about 15 wt % and not more than about 35 wt %. There is a problem of lowering of flexural modulus if the amount is below about 15 wt %, while there is little improvement in shrinkage anisotropy if the amount is above about 35 wt %.

The clay is also preferred to be surface-modified by coupling treatment with silane for the prepared resin composition to have desired property. Preferably, the clay has a diameter of not less than about 1 μm and not more than about 4 μm. There is a problem in processibility if the diameter is below about 1 μm, while there is little improvement in shrinkage anisotropy if the diameter is above about 4 μm.

Representative examples of the clay according to the present invention are talc, mica, clay, CaCO₃ and Wollastonite. Translink445® produced by Engel Hardt may also be used. The clay is preferred to be comprised in the total resin composition in the amount of not less than about 5 wt % and not more than about 25 wt %. There are problems of lowered heat resistance and deteriorated surface property if the content is above about 25 wt %, while there is little improvement in shrinkage anisotropy if the content is below about 5 wt %.

Meanwhile, the clay should be used in combination with the glass fiber, and the summed amount of the glass fiber and the clay is preferred to be not less than about 30 wt % and not more than about 45 wt % on the basis of the total weight of the polyamide resin composition. Rigidity and heat resistance are lowered if the amount is below about 30 wt %, while surface of manufactured goods is deteriorated and fluidity is lowered if the amount is above about 45 wt %.

If the amounts of the additives are out of the above-mentioned ranges, noise may be generated due to lack of balance at high-speed revolution when the polyamide resin composition is applied to an automobile engine parts such a radiator fan and shroud.

In addition, a plasticizer may be further added to the polyamide resin composition to lower a viscosity and a crystallization rate and accomplish desired surface property when applied to the microcellular foam process. The plasticizer is an additive for increasing softness and elasticity, and conventional plasticizer may be used in the present invention, the representative examples of which are lactam-based plasticizer, such as, caprolactam and lauryl lactam, sulfonamide-based plasticizer, phthalate-based plasticizer, epoxide-based plasticizer, adipate-based plasticizer, azelate-based plasticizer, trimeliate-based plasticizer, phosphate-based plasticizer, polyester-based plasticizer, dicarboxylic acid-based plasticizer, and the like. For example, phthalate-based plasticizer, such as, dioctyl phthalate, diisooctyl phthalate, dioctyl terephthalate, heptyl phthalate butyl phthalate, and the like; epoxide-based plasticizer, such as, soybean oil epoxide; phosphate-based plasticizer such as tricresyl phosphate, cresyldiphenyl phosphate, isodesyldiphenyl phosphate, and the like; adipate-based plasticizer, such as, dibutyl selacate diisodesyl adipate, diethylhepsyl adipate, and the like; and dicarboxylic acid-based plasticizer, such as, trioctyl trimeritate, acrylate citrate, and the like may be used as a plasticizer in the present invention. In particular, benzosulfonamide-based, especially, benzosulfonamide-based, or dicarboxylic acid plasticizer is preferable considering a volatility and a compatibility with polyamide.

Among the dicarboxylic acid, there are (i) oxalic acid, succinic acid, tartaric acid, glutamic acid, adipic acid (according to the number of carbon atom), (ii) maleic acid and fumaric acid (with unsaturated group), and (iii) phthalic acid (aromatic dicarboxylic acid).

When dicarboxylic acid-based plasticizers are used in the present invention, terephthalic acid or isophthalic acid may be used phthalic acid, which is for preparing polyester and a nylon copolymer. These materials are white crystals and are prepared by oxidizing p-xylene with potassium permanganate, chromium trioxide or diluted nitric acid. Alternatively, it is industrially prepared according to the air oxidation of p-xylene by using heavy metal catalyst such as cobalt or according to Henkel method of isomerizing potassium phthalate at high temperature. The dicarboxylic acid-based plasticizer in the present invention causes melt viscosity of the total composition as well as the crystallization rate of polyamide resin to be retarded, thereby improving the surface property of the manufactured goods.

Preferably, the plasticizer is comprised in the total resin composition in an amount of not less than about 0.1 wt % and not more than about 3 wt %. The effect is negligible when the content is below about 0.1 wt %, while the surface property is deteriorated when the content is above about 3 wt %. In particular, the dicarboxylic acid-based is preferred to be comprised in an amount of not less than about 0.1 wt % and not more than about 2 wt % on a basis of total weight of said polyamide resin composition. The effect of improving fluidity and reducing the crystallization rate is negligible when the content is below about 0.1 wt %, while the mechanical strength is deteriorated due to the abrupt lowering of viscosity when the content is above about 2 wt %.

Further, a heat resistant agent or a UV stabilizer may be added into the resin composition within the scope of the object of the present invention. IrganoxB1171® (commercially available, 1:1 mixture of tris(2,4-di-tert-butylphenyl)phosphate and N,N′-hexamethylene-bis(3,5-di- tert-butyl-4-hydroxyhydrocynamide) may be used as the heat resistant agent in the present invention. Meanwhile, Tinuvin234® (hydroxyl phenylbenzotriazole, a UV absorbent) or Tinuvin770® (tetramethyl piperidine-structured hindered amine, a peroxide decomposer or radical scarvenger) may be used as the UV stabilizer in the present invention.

The conventional microcellular foaming injection molding process may be used to prepare the polyamide composition of the present invention, as will be appreciated by one of ordinary skill in the art. Preferably, a twin screw type extruder with three inlets is used, and through each inlet (i) polyamide and a plasticizer, (ii) glass fiber and (iii) mineral are added to maximize the blending effect. Further, residence time is preferred to be minimized to prevent thermal decomposition of the resin composition during blending. According to one aspect of the present invention, 200-300 rpm is preferred considering the dispersibility of the resin composition of the present invention.

Therefore, the resin composition of the present invention may accomplish the object of the present invention, i.e. (i) improving ductility, chemical resistance, adding effect, surface properties by adopting polyamide as a base polymer, (ii) controlling the viscosity and the crystallization rate by using sulfonamide-based or dicarboxylic acid-based plasticizer, thereby enabling to improve the surface property. Further, the resin composition of the present invention enables to decrease the weight of the manufactured goods and improve surface properties, without showing any defect, such as warpage, surface sink, deflection, flowmark and weldline, or any reinforcing materials, such as glass fiber and clay, on the surface, while elevating other physical properties such as dimensional stability heat resistance, fluidity and rigidity, thereby being appropriate for use in automobile such as a radiator fan, a shroud, an intercooler air duct, a timing belt cover or a lid filler door. Specifically, there is an advantage of lowering the cost due to the decrease in the cycle time of injection molding process. Moreover, the present invention obtains the effect of overcoming the drawbacks of the conventional method, i.e. (i) glass fiber or mineral emerges on the surface during the injection molding, and (ii) strength is lowered as compared with that prepared according to the solid process due to the formation of cell inside the resin.

Furthermore, the present invention may decrease the anisotropy, below 120% as set forth hereunder, which is induced by the use of need-shape reinforcing material such as glass fiber and deteriorates the surface property by causing warpage, surface sink, deflection, flowmark and weldline. Further, the present invention may comply with the requirement of the heat deflection temperature, above 230° C., which is essential to be used in the automobile parts. Conclusively, the resin composition is appropriate for being used in the automobile parts such as a radiator fan, a shroud, an intercooler air duct, a lid filler, a timing belt cover or a lid filler door.

### EXAMPLES

Examples are provided hereunder to explain the present invention in more detail, however, these examples are presented for the purpose of assisting the reader to understand the present invention and should not be interpreted as limiting the present invention.

### Examples 1-9 & Comparative Examples 1-9

Reactants are added into and blended in a twin screw extruder heated at 280° C. as set forth in the following TABLE 2. Chip-shaped polyamide resin composition I prepared after drying at 90° C. for 5 hours. As mentioned above, polyamide 6 and polyamide 66 are polymers of formulas 1 and 2, respectively. Translink445® (produced by Engel Hardt) was used as clay and CS331® was used as glass fiber.

Conditions of Microcellular Foaming Injection Molding:

Microcellular foaming injection molding process was conducted under the following conditions. Meanwhile, solid process and microcellular foaming injection molding process may be carried out in combination under the following conditions:
Weight loss: 10%
Cylinder temperature: 290×295×300° C.
Molding temperature: 80° C.
Injection rate: 50×100×50 mm/sec
Injection time: 1 sec
Supercritical fluid exposure time: 2 sec

150 Ts injection molding machine, which is equipped with an interface kit, a supercritical fluid port, a controller and a injector, is used in the Examples. Meanwhile, N₂ was used as the supercritical fluid, and weight loss is controlled to be 10%.

TABLE 2

| | | | Glass | | |
|---|---|---|---|---|---|
| | Polyamide | Polyamide 6 | fiber | Clay | Plasticizer¹⁾ |
| Example | 66 (wt %) | (wt %) | (wt %) | (wt %) | (wt %) |
| Ex. 1 | 64 | — | 15 | 20 | 1 |
| Ex. 2 | 58.8 | — | 30 | 10 | 1.2 |
| Ex. 3 | 68 | — | 25 | 5 | 2 |
| Ex. 4 | 54.9 | — | 35 | 10 | 0.1 |
| Ex. 5 | 63 | — | 20 | 15 | 2 |
| Ex. 6 | 45.7 | 13 | 25 | 15 | 1.5 |
| Ex. 7 | 30.7 | 28 | 30 | 10 | 1.5 |
| Ex. 8 | 35.7 | 18 | 25 | 20 | 1.3 |
| Ex. 9 | 30.5 | 24 | 20 | 25 | 0.5 |
| Comp. Ex. 1 | 54 | — | 15 | 30 | 1 |
| Comp. Ex. 2 | 67 | — | 30 | 2 | 1 |
| Comp. Ex. 3 | 69 | — | 10 | 20 | 1 |
| Comp. Ex. 4 | 49 | — | 40 | 10 | 1 |
| Comp. Ex. 5 | 59.95 | — | 25 | 15 | 0.05 |
| Comp. Ex. 6 | 56.5 | — | 25 | 15 | 3.5 |
| Comp. Ex. 7 | 23.5 | 35 | 25 | 15 | 1.5 |
| Comp. Ex. 8 | 64 | 10 | 15 | 10 | 1 |
| Comp. Ex. 9 | 49.5 | — | 30 | 20 | 1.5 |

¹⁾Benzosulfonamide

### Examples 10-18 & Comparative Examples 10-18

Reactants are added into and blended in a twin screw extruder heated at 280° C. as set forth in the following TABLE 3. Chip-shaped polyamide resin composition I prepared after drying at 90° C. for 5 hours. The same ingredients are used as in the Example 1 except that terephthalic acid (TPA) or isophthalic acid (IPA) was used as a plasiticizer.

TABLE 3

| | | | Glass | | | |
|---|---|---|---|---|---|---|
| | Polyamide | Polyamide | fiber | Clay | Plasticizer | |
| Example | 66 (wt %) | 6 (wt %) | (wt %) | (wt %) | (wt %) | |
| Ex. 10 | 64.2 | — | 15 | 20 | 0.8 | TPA |
| Ex. 11 | 59.2 | — | 30 | 10 | 0.8 | IPA |
| Ex. 12 | 68.7 | — | 25 | 5 | 1.3 | TPA |
| Ex. 13 | 54.9 | — | 35 | 10 | 0.1 | TPA |
| Ex. 14 | 63 | — | 20 | 15 | 2 | IPA |
| Ex. 15 | 45.7 | 13.5 | 30 | 10 | 0.8 | TPA |
| Ex. 16 | 30.7 | 28.5 | 30 | 10 | 0.8 | IPA |
| Ex. 17 | 40.7 | 18 | 25 | 15 | 1.3 | TPA |
| Ex. 18 | 30.5 | 29 | 25 | 15 | 0.5 | IPA |
| Comp. Ex. 10 | 54.5 | — | 15 | 30 | 0.5 | TPA |
| Comp. Ex. 11 | 67.5 | — | 30 | 2 | 0.5 | IPA |
| Comp. Ex. 12 | 69.5 | — | 10 | 20 | 0.5 | TPA |
| Comp. Ex. 13 | 49.5 | — | 40 | 10 | 0.5 | TPA |
| Comp. Ex. 14 | 59.95 | — | 25 | 15 | 0.05 | IPA |
| Comp. Ex. 15 | 57.5 | — | 25 | 15 | 2.5 | TPA |
| Comp. Ex. 16 | 24.5 | 35 | 25 | 15 | 0.5 | IPA |
| Comp. Ex. 17 | 64.5 | 10 | 15 | 10 | 0.5 | TPA |
| Comp. Ex. 18 | 49.5 | — | 30 | 20 | 0.5 | IPA |

### Experimental Examples

Test samples were prepared by using the resin compositions of Examples 1-18 and Comparative Examples 1-18. Tests to evaluate the physical properties were conducted according to the followings, and the results are provided in TABLES 4-6 below.

TABLE 4 shows the physical properties of the test samples prepared by using the resin compositions of Examples 1-9 and Comparative Examples 1-9. TABLE 5 shows the physical properties of the test samples prepared according to the microcellular foaming process by using the resin compositions of Examples 10-18 and Comparative Examples 10-18. TABLE 6 shows the physical properties of the test samples prepared according to the conventional injection molding process (a screw-type injection machine) by using the resin compositions of Examples 10-18 and Comparative Examples 10-18 under the same temperature with the blend temperature.

Test Items & Test Methods:

Flexural Modulus:

⅛ inch test samples were prepared and tested according to ASTM D790.

Impact Strength:

¼ inch test samples were prepared and notched Izod impact strength tests were conducted according to ASTM D256.

Heat Deflection Temperature:

¼ inch test samples were prepared and heat deflection temperature were evaluated under the load of 18.6 kg/cm² according to ASTM D648.

Surface Property:

Blended resin compositions of the present invention (Examples 1-9 & Comparative Examples 1-9) was prepared in the form of a chip, and dried at 90° C. for 5 hours. Microcellular injection molding was conducted at an injection temperature of 270° C. and a mold temperature of 40° C. by using a cavity with a dimension of 350×100×b 2.8 mm³ and a direct center gate shaped square molding with a diameter of 7 mm and a length of 80 mm. Flowmarks and mineral emergings were observed in the region of the gate with the naked eye. Meanwhile, blended resin compositions of the present invention (Examples 10-18 & Comparative Examples 10-18) was prepared in the form of a chip by the same method. Microcellular injection molding was conducted at an injection temperature of 270° C. and a mold temperature of 20° C. by using the same cavity and molding. Flowmarks and mineral emergings were observed in the region of the gate with the naked eye.

Shrinkage Anisotropy:

Flow-direction and radial-direction shrinkages were measured at the gate by using a circular plate shaped molding having a dimension of 100×100×3.2 mm³, and shrinkage anisotropy was calculated using the following Formula l. Injection molding conditions were the same with those in the tests for evaluating surface properties. Shrinkage anisotropy above 120% was considered to be bad.
Shrinkage anisotropy (%)=100*(FDS⁽¹⁾−RDS⁽²⁾)/FDS Formula 1
⁽¹⁾FDS: Flow directional shrinkage (%)

⁽²⁾RDS: Radial directional shrinkage (%)

TABLE 4

| | | Impact | | Surface property | | |
|---|---|---|---|---|---|---|
| | Flexural | strength | Shrinkage | | Surface | |
| | shrinkage | (kgcm/ | anisotropy | Flow | emerg- | Weld |
| Example | (kg/cm²) | cm²) | (%) | mark | ings | line |
| Ex. 1 | 60,600 | 5.7 | 105 | ∘ | ∘ | ∘ |
| Ex. 2 | 74,800 | 6.5 | 107 | ∘ | ∘ | ∘ |
| Ex. 3 | 67,900 | 6.1 | 110 | ∘ | ∘ | ∘ |
| Ex. 4 | 85,300 | 6.8 | 108 | ∘ | ∘ | ∘ |
| Ex. 5 | 68,000 | 5.8 | 104 | ∘ | ∘ | ∘ |
| Ex. 6 | 71,800 | 6 | 105 | ∘ | ∘ | ∘ |
| Ex. 7 | 69,300 | 6.2 | 106 | ∘ | ∘ | ∘ |
| Ex. 8 | 68,100 | 6.3 | 104 | ∘ | ∘ | ∘ |
| Ex. 9 | 66,200 | 5.8 | 103 | ∘ | ∘ | ∘ |
| Comp. Ex. 1 | 52,400 | 5.1 | 108 | ∘ | x | ∘ |
| Comp. Ex. 2 | 67,800 | 6.5 | 122 | x | x | ∘ |
| Comp. Ex. 3 | 48,900 | 4.8 | 116 | ∘ | x | ∘ |
| Comp. Ex. 4 | 79,500 | 6.8 | 125 | x | x | x |
| Comp. Ex. 5 | 69,400 | 6.2 | 108 | x | x | x |
| Comp. Ex. 6 | 51,500 | 6 | 105 | x | ∘ | ∘ |
| Comp. Ex. 7 | 60,600 | 5.5 | 105 | x | ∘ | ∘ |
| Comp. Ex. 8 | 50,300 | 5 | 117 | ∘ | ∘ | ∘ |
| Comp. Ex. 9 | 70,000 | 6.2 | 105 | x | x | x |

∘: good,
x: bad

TABLE 5

| | | Heat | | | | |
|---|---|---|---|---|---|---|
| | | deflec- | | | | |
| | | tion | | Surface property | | |
| | Flexural | temper- | Shrinkage | | Surface | |
| | shrinkage | ature | anisotropy | Flow | emerg- | Weld |
| Example | (kg/cm²) | (° C.) | (%) | mark | ings | line |
| Ex. 10 | 63,000 | 240 | 104 | ∘ | ∘ | ∘ |
| Ex. 11 | 75,000 | 245 | 107 | ∘ | ∘ | ∘ |
| Ex. 12 | 67,000 | 244 | 110 | ∘ | ∘ | ∘ |
| Ex. 13 | 86,500 | 247 | 103 | ∘ | ∘ | ∘ |
| Ex. 14 | 70,000 | 239 | 102 | ∘ | ∘ | ∘ |
| Ex. 15 | 72,000 | 235 | 103 | ∘ | ∘ | ∘ |
| Ex. 16 | 72,000 | 228 | 105 | ∘ | ∘ | ∘ |
| Ex. 17 | 65,000 | 236 | 102 | ∘ | ∘ | ∘ |
| Ex. 18 | 64,500 | 228 | 103 | ∘ | ∘ | ∘ |
| Comp. Ex. 10 | 55,000 | 220 | 112 | x | x | ∘ |
| Comp. Ex. 11 | 68,000 | 235 | 121 | x | x | ∘ |
| Comp. Ex. 12 | 49,000 | 220 | 115 | x | x | ∘ |
| Comp. Ex. 13 | 79,500 | 240 | 123 | x | x | ∘ |
| Comp. Ex. 14 | 70,000 | 240 | 106 | x | x | ∘ |
| Comp. Ex. 15 | 50,000 | 210 | 103 | ∘ | ∘ | ∘ |
| Comp. Ex. 16 | 61,000 | 211 | 104 | x | ∘ | ∘ |
| Comp. Ex. 17 | 50,000 | 220 | 112 | x | x | ∘ |
| Comp. Ex. 18 | 70,000 | 247 | 105 | x | x | x |

∘: good,
x: bad

TABLE 6

| | | Heat | | | | |
|---|---|---|---|---|---|---|
| | | deflec- | | | | |
| | | tion | | Surface property | | |
| | Flexural | temper- | Shrinkage | | Surface | |
| | shrinkage | ature | anisotropy | Flow- | emerg- | Weld |
| Example | (kg/cm²) | (° C.) | (%) | mark | ings | line |
| Ex. 1 | 71,000 | 243 | 110 | ∘ | ∘ | ∘ |
| Ex. 2 | 82,000 | 249 | 115 | ∘ | ∘ | ∘ |
| Ex. 3 | 74,000 | 247 | 117 | ∘ | ∘ | ∘ |
| Ex. 4 | 95,500 | 251 | 108 | ∘ | ∘ | ∘ |
| Ex. 5 | 75,000 | 245 | 107 | ∘ | ∘ | ∘ |
| Ex. 6 | 79,000 | 240 | 114 | ∘ | ∘ | ∘ |
| Ex. 7 | 76,000 | 231 | 115 | ∘ | ∘ | ∘ |
| Ex. 8 | 72,000 | 239 | 108 | ∘ | ∘ | ∘ |
| Ex. 9 | 70,500 | 230 | 109 | ∘ | ∘ | ∘ |
| Comp. Ex. 1 | 62,000 | 231 | 122 | x | x | ∘ |
| Comp. Ex. 2 | 78,000 | 244 | 141 | ∘ | ∘ | x |
| Comp. Ex. 3 | 57,000 | 226 | 124 | x | x | ∘ |
| Comp. Ex. 4 | 98,000 | 251 | 142 | x | x | x |
| Comp. Ex. 5 | 73,000 | 245 | 110 | x | x | x |
| Comp. Ex. 6 | 53,000 | 220 | 111 | ∘ | ∘ | ∘ |
| Comp. Ex. 7 | 65,000 | 219 | 114 | ∘ | ∘ | ∘ |
| Comp. Ex. 8 | 58,000 | 223 | 132 | ∘ | ∘ | x |
| Comp. Ex. 9 | 75,000 | 250 | 119 | x | x | x |

∘: good,
x: bad

As shown in the TABLES 4-6, the polyamide resin compositions of the present invention are verified to be superior to those of Comparative Examples in flexural strength, impact strength, and shrinkage anisotropy. The surface property is observed to be much improved without showing any flowmark or weld line, thus enabling the resin compositions to be appropriate for use in microcellular foaming injection molding process. Specifically, the resin composition of the present invention enables a decrease in the weight of the manufactured goods and improved surface properties, without showing any defect, such as surface sink and flowmark, or any reinforcing materials, such as glass fiber and clay, on the surface, while elevating other physical properties such as dimensional stability, heat resistance, fluidity and rigidity, thereby being appropriate for use in automobile parts such as a radiator fan, a shroud, an intercooler air duct, a timing belt cover or a lid filler door.

1. A polyamide resin composition for microcellular foaming injection molding, the composition comprising:
(i) 50-75 wt % of a polyamide component which is a polyamide of formula 1 (polyamide 6) or a polymer alloyed with said polyamide and a polyamide of formula 2 (polyamide 66), 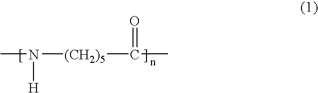
wherein n is an integer of 200-15,000, 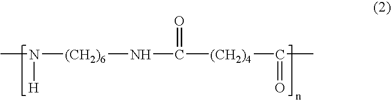
wherein n is an integer of 200-15,000;
(ii) 15-35 wt % of glass fiber;
(iii) 5-25 wt % of clay; and
(iv) 0.1-3 wt % of benzosulfonamide-based or dicarboxylic acid-based plasticizer.

2. The polyamide resin composition of claim 1, wherein the weight ratio of said polyamide 6 to said polyamide 66 in said alloyed polymer is lower than 1:1.

3. The polyamide resin composition of claim 1, wherein said polyamide component has a relative viscosity of 2.3-3.0.

4. The polyamide resin composition of claim 1, wherein said glass fiber is chop-shaped or fibrous and has a length of 3-3.5 mm.

5. The polyamide resin composition of claim 1, wherein said clay is surface-modified by using amino silane and has a diameter of 1-4 μm.

6. The polyamide resin composition of claim 1, wherein the summed amount of said fiber glass and said clay is 30-45 wt % on the basis of the total weight of said polyamide resin composition.

7. The polyamide resin composition of claim 1, having physical properties of (i) 62,000 kg/cm² or higher of flexural modulus according to ASTM D790, (ii) 5.5 kg.cm/cm or higher of impact strength according to ASTM D256, and (iii) 120% or less of shrinkage in a flow direction and a radial direction.

8. The polyamide resin composition of claim 1, having a heat deflection temperature of 230° C. or higher according to ASTM D648.

9. The polyamide resin composition of claim 1, wherein said dicarboxylic acid-based plasticizer is terephthalic acid or isophthalic acid.

10. The polyamide resin composition of claim 1, wherein said dicarboxylic acid-based plasticizer comprises an amount of not less than about 0.1 wt % and not more than about 2 wt % on a basis of total weight of said polyamide resin composition.

11. Parts for an automobile being prepared by using the polyamide resin composition of claim 1.

12. The parts for an automobile of claim 11, wherein said parts are selected from the group consisting of a radiator fan, a shroud, an intercooler air duct, a timing belt cover, and a lid filler door.

13. A polyamide resin composition for microcellular foaming injection molding, the composition comprising:
(a) not less than about 50 wt % and not more than about 75 wt % of a polyamide component, the polyamide component being a polyamide of formula 1 (polyamide 6) or a polymer alloyed with said polyamide and a polyamide of formula 2 (polyamide 66), wherein forumla 1 and formula 2 are; 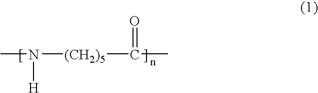
wherein n is an integer of not less than about 200 and not more than about 15,000, 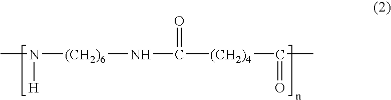
wherein n is an integer of not less than about 200 and not more than about 15,000;
(b) not less than about 15 wt % and not more than about 35 wt % of glass fiber;
(c) not less than about 5 wt % and not more than about 25 wt % of clay; and
(d) not less than about 0.1 wt % and not more than about 3 wt % of a benzosulfonamide-based or a dicarboxylic acid-based plasticizer.

14. The polyamide resin composition of claim 13, wherein the weight ratio of said polyamide 6 to said polyamide 66 in said alloyed polymer is not less than about 1:1.

15. The polyamide resin composition of claim 13, wherein said polyamide component has a relative viscosity of not less than about 2.3 and not more than about 3.0.

16. The polyamide resin composition of claim 13, wherein said glass fiber has a length of not less than about 3 mm and not more than about 3.5 mm.

17. The polyamide resin composition of claim 13, wherein said clay is surface-modified by using amino silane and has a diameter of not less than about 1 μm and not more than about 4 μm.

18. The polyamide resin composition of claim 13, wherein the summed amount of said fiber glass and said clay is not less than about 30 wt % and not more than about 45 wt % on the basis of a total weight of said polyamide resin composition.

19. The polyamide resin composition of claim 13, having physical properties of (i) 62,000 kg/cm² or higher of flexural modulus according to ASTM D790, (ii) 5.5 kg.cm/cm or higher of impact strength according to ASTM D256, and (iii) 120% or less of shrinkage in a flow direction and a radial direction.

20. The polyamide resin composition of claim 13, having a heat deflection temperature of about 230° C. or higher according to ASTM D648.
